(19) United States
(12) Patent Application Publication
(10) Pub. No.: US 2012/0146320 A1
(43) Pub. Date: Jun. 14, 2012

(54) Binding Device for Children's Books

(76) Inventor: Christian Noel Guy Legrand, Nonthaburi (TH)

(21) Appl. No.: 13/094,016

(22) Filed: Apr. 26, 2011

(30) Foreign Application Priority Data
Dec. 10, 2010 (EM) 10380149.4

(51) Int. Cl. B42D 1/00

(52) U.S. Cl. 281/21.1

(57) ABSTRACT

A book binding device is provided for use with children's books consisting of a plurality of plates that can be made of a foam rubber-like material, where such plates are joined together by means of cardboard or paper sheets glued to one of the sides of such sheets that incorporate the motifs of the book, such as legends, drawings, etc. The whole book is reinforced by means of a spine consisting of two or three layers, an intermediate cloth layer, which, is the reinforcing means, and one or two outer layers, the first one of them, if any, or the cloth itself being used to fix the spine to the book, while the outer paper sheet has been silk printed with the appropriate motifs to determine the outer face of the spine on the book.

### FIELD OF THE INVENTION

The present invention refers to a binding device for children's books, which can be specifically applied to a type of books consisting of several plates made of foam or rubber, that are bound together through the relevant paper sheets that incorporate the motifs of the children's book, which can be either texts or figures; the plates may even incorporate die cut figures belonging to a jigsaw puzzle.

The object of the invention is to reinforce the binding of all the plates that make up the pages of the book and to provide binding means that are structurally simple, can be easily applied, and that can be printed with any type of silk screen printing technique.

### BACKGROUND OF THE INVENTION

The simplest way of binding a book consists in applying a cardboard plate as a single piece, which forms the cover, the back, and the spine of the book, such cardboard piece or plate incorporating a series of grooves that define the gluing areas.

This binding system, although it is quite simple, straightforward and easy to carry out and, consequently, very cheap in terms of labour, has the drawback that in the case of cardboard books with a thickness ranging between 10 and 12 mm, when they are opened by children, to whom these books are targeted, they can introduce a finger between the spine and the pages of the book, so that they bruise themselves when they try to take the finger out, since when so doing the book gradually closes and the damages caused are increasingly greater.

There is another system that consists in completely covering the spine of the book with a cardboard cloth binding, which has been previously covered with paper to allow a proper gluing. However, since the cloth does not adhere to the cardboard without the paper, the glue stains are visible, and the product cannot be sold.

This system or procedure, based on using “cloth paper” for binding children's books is very well-known, although it is more expensive in terms of labour and material than the book binding procedure based on a single cardboard piece.

Furthermore, cloth paper may be very expensive when the cloth is printed in colours, if it is acquired in small quantities.

Therefore, in those cases where the book binding is based on the application of a cloth spine, this will not allow one to obtain a nice four-colour printing, while if the spine completely consists in cardboard, as it has been previously said, along with the front and the back of the book, it is not possible to guarantee an optimum level of safety for the child, which may be less than 36 months old.

Another way to obtain a perfectly printed book spine consists in covering the spine with printed paper. However, in this case, the book is not solid enough, as far as the joining of the different rubber or foam plates used as book pages is concerned.

### SUMMARY OF THE INVENTION

The binding device for a children's book that is the subject matter of this invention has been designed to solve the drawbacks previously mentioned, on the basis of a simple, but very efficient, solution.

Specifically, the device according to the invention has been foreseen to be used with the type of children's books consisting of a plurality of thick foam or rubber plates correlatively joined to each other by means of cardboard or paper sheets where the motifs of the book have been printed, so that although such sheets or cardboards correlatively join together all the sheets that form the pages of the book, the spine of the book is not sufficiently reinforced or, in other words, it is not adequately bound.

Therefore, the book binding device according to the invention is applicable to the type of book that has been previously mentioned and presents the peculiarity that it consists in a spine formed by two or three layers, an intermediate cloth layer, and one or two outer paper layers. One of such layers can be an inner one, to be fixed on the book spine, while the other layer is an outer one, where the desired motifs have been previously printed, namely the title of the book, the publishing house, its contents, etc.

This way, a book binding spine is obtained, which on one side it is covered with colour printed paper, which has been previously prepared before gluing it to the cloth, and on the other side, which is glued to the opposite, inner side of the cloth, a second paper sheet may be incorporated in order to fix the spine to the book, thus adequately reinforcing the spine by means of the cloth that has been integrated inside the book between the above mentioned two paper sheets.

### DESCRIPTION OF THE DRAWINGS

In order to complement the following description of a preferred embodiment of the invention and to contribute to a better comprehension of the features of same, we enclose, for illustration purposes and without limitation, a set of drawings, where the following has been depicted:

FIG. 1.—It shows a sectional view of the spine, consisting of three layers, an intermediate cloth layer and two outer paper layers, that form the binding method that is the subject matter of the invention.

FIG. 2.—It shows a practical application of the book binding spine applied to a children's book, whose pages consist of thick foam or rubber plates.

FIG. 3.—It shows a side view of the book depicted in the previous figure, with two pages, each one consisting of a plate, in an opening position, showing the correlative joining of the different pages by means of the inner sheet or cardboard which has been glued to the pages, while the outer part of the book spine includes the reinforcement formed by the three overlapped layers depicted in FIG. 1.

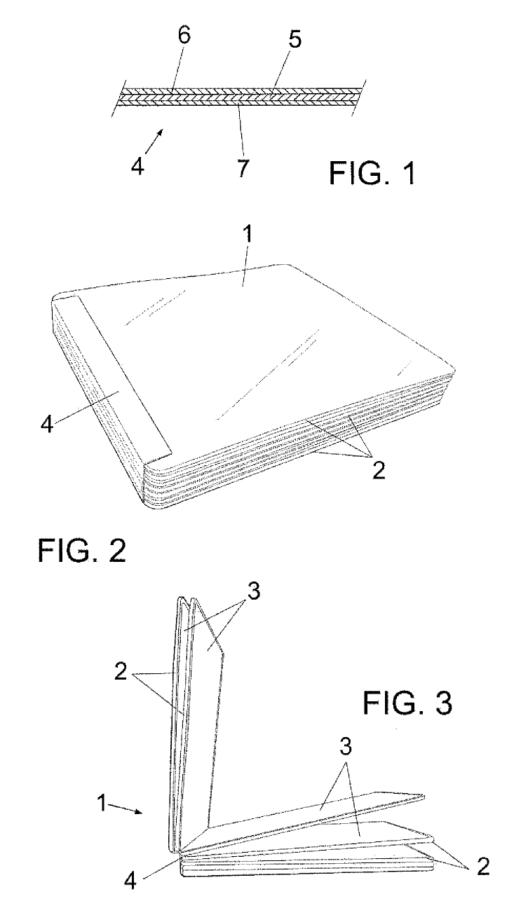

### DETAILED DESCRIPTION OF THE PREFERRED EMBODIMENT

As it can be seen in the figures, the book binding device which is the subject matter of the invention can be applied to children's books (1) consisting of a plurality of thick plates (2), made of foam, rubber or any other suitable material, that are correlatively bound together in an overlapped manner, by means of the relevant sheets or cardboards (3), that can be silk printed with the relevant motifs of the book, such as sentences extracted from a tale, legends, etc.; the sheets (2) may be even die cut with shapes of figures to obtain a jigsaw puzzle.

On the basis of such characteristics, the book binding device is formed by a spine (4) that provides strength and rigidity to the book (1), such spine (4) being formed by a cloth (5) and one or two outer layers (6 and 7) made of paper, so that the paper sheet (6) can be used, for instance, to fix the whole set or spine (4) on the book (1), while the paper sheet (7) may be used to print different motifs, and the silk printing technique is applied to the spine before fixing it to the cloth (5).

This means that the spine (4) consists in a cloth (5) that may incorporate, on any of its sides, a paper sheet (6) that, after gluing it, allows to completely fix the spine (4) to the book (1), while at the opposite external side, a paper sheet (7), previously silk printed with any motifs or legends desired, is fixed to the cloth (5), thus obtaining a spine covered with paper printed in four colours and a reinforced spine, thanks to the cloth (5) inserted and fixed between one or two paper sheets (6 and 7).

1. A binding device for children's books for application to books consisting of a plurality of thick foam, rubber-like plates, correlatively joined together by means of paper sheets that protect all the sides of the sheets, where the motifs of the books, either drawings, legends, or any other motif are printed, characterized in that it consists in fixing a reinforcing spine (4), formed by two or three layers, on the book spine (1) formed by the plates (2), the reinforcing spine (4) consisting of two or three layers, an intermediate cloth layer and one or two outer paper layers (6 and 7).

2. A binding device for children's books, according to claim 1, characterized in that one of the paper sheets (6) that are fixed to the cloth (5) or the cloth (5) itself of the spine (4) forms the means to fix it to the book spine (1), while the opposite paper sheet (7) that can be seen at the outer side of the spine (4), has been previously silk printed with any motif or legend before fixing it on the cloth (5), such paper sheet (7) forming the outer covering of the spine (4).
